(19) United States
(12) Patent Application Publication
(10) Pub. No.: US 2010/0010105 A1
(43) Pub. Date: Jan. 14, 2010

(54) ELASTIC VITRIFICATION OF EMULSIONS BY DROPLET RUPTURING

(75) Inventors: Thomas G. Mason, Los Angeles, CA (US); James N. Wilking, Los Angeles, CA (US); Sara M. Graves, Los Angeles, CA (US); Kieche Meleson, Los Angeles, CA (US)

Correspondence Address: VENABLE LLP, P.O. BOX 34385, WASHINGTON, DC, 20043-9998, US

(73) Assignee: The Regents of the University of California, Oakland, CA (US)

(21) Appl. No.: 12/518,792

(22) PCT Filed: Jan. 22, 2008
(86) PCT No.: PCT/US2008/000800

§ 371 Date: Jun. 11, 2009

Related U.S. Application Data
(60) Provisional application No. 60/881,161, filed on Jan. 19, 2007.

(51) Int. Cl. B01F 3/08; B01J 13/00

(52) U.S. Cl. 516/53; 516/9

(57) ABSTRACT

A method of producing an elastic material including providing a viscous material having an initial material composition thereof, the viscous material being a multiphase dispersion comprising a plurality of discrete elements of a first component dispersed within a continuous fluid phase of a second component; and applying stress to the plurality of discrete elements of the first component to break up the plurality of discrete elements into a second plurality of discrete elements having a greater number of discrete elements than the first plurality of discrete elements. The discrete elements of the second plurality of discrete elements have at least one of a composition or a surface layer that provides at least a repulsion between adjacent discrete elements to prevent the discrete elements from irreversibly coalescing or irreversibly re-uniting, the viscous material thus irreversibly becoming an elastic material having a same material composition as the initial material composition.

### CROSS-REFERENCE TO RELATED APPLICATION

This application claims priority to U.S. Provisional Application No. 60/881,161 filed Jan. 19, 2007, the entire contents of which are hereby incorporated by reference.

### BACKGROUND

1. Field of Invention

The present invention relates to methods of producing elastic materials from viscous materials and the materials made by the methods.

2. Discussion of Related Art

Colloidal dispersions can behave in interesting and unusual ways when subjected to high shear stresses that alter their structures away from thermal equilibrium (W. B. Russel, D. A. Saville, and W. R. Schowalter, Colloidal Dispersions (Cambridge University Press, Cambridge, 1989)). For instance, shearing a polymer entanglement solution can cause the polymers to stretch and even disentangle, leading to non-Newtonian shear-thinning behavior; the solution's viscosity, η, decreases at higher shear rates, \dot{γ} (R. G. Larson, The Structure and Rheology of Complex Fluids (Oxford University Press, New York, 1999)). Other dispersions, such as concentrated hard spheres in a simple liquid, can exhibit a shear-thickening viscosity (J. Bender, and N. J. Wagner, J. Rheol. 40, 899 (1996)), and the dispersion increasingly resists more vigorous shear: η rises with \dot{γ}. Attractive hydrodynamic interactions between the hard spheres can lead to the formation of clusters of spheres that jam and can even percolate, effectively causing η to diverge (B. J. Maranzano, and N. J. Wagner, J. Chem. Phys. 117, 10291 (2002)). This increase in η is reversible; thermal forces redistribute the spheres and the equilibrium particle structure returns. Clay-polymer “shake-gels” can become temporarily elastic due to changes in the structure of interacting components after \dot{γ} is raised (B. Cabane, K. Wong, P. Lindner, and F. Lafuma, J. Rheol. 41, 531 (1997); J. Zebrowski, V. Prasad, W. Zhang, L. M. Walker, and D. A. Weitz, Colloids Surfaces A 213, 189 (2003); and D. C. Pozzo, and L. M. Walker, Colloids Surfaces A 240, 187 (2004)). All of these flow-induced rheological changes do not persist for long aging times after the flow has ceased.

Although it is relatively easy to cause a variety of complex dispersions in viscous liquids to become permanently elastic by changing their compositions, in general, it is quite difficult to transform a dispersion of repulsive objects that behaves initially like a simple liquid irreversibly into an elastic solid by subjecting it to a history of extreme shear without changing its composition. When making mayonnaise, an emulsion of oil droplets in an aqueous solution stabilized against coalescence by amphiphilic lipids and proteins from egg yolk, the elasticity is typically achieved by slowly adding more oil while vigorously stirring. The stirring causes the oil to be shear-ruptured from the macroscopic scale down into microscale droplets through the capillary instability (J. M. Rallison, Ann. Rev. Fluid Mech. 16, 45 (1984)), which is driven by the surface tension, σ. As the droplet volume fraction, φ, increases and oil droplets begin to jam together and deform, the mayonnaise develops a shear elastic modulus, G′, that is strong enough to overcome gravity, and the emulsion “sets”—it appears to become solid. The elasticity arises from work that must be done against surface tension to further deform droplets that are packed into a disordered foam-like structure (T. G. Mason, J. Bibette, and D. A. Weitz, Phys. Rev. Lett. 75, 2051 (1995)). This simple example shows that it is possible to transform a liquid-like dispersion into an elastic one by raising φ while shearing. Concentrated emulsions have been made somewhat more elastic through moderate shear introduced by sinusoidal amplitude variation rheometry (T. G. Mason, and P. K. Rai, J. Rheol. 47, 513 (2003)). This approach has only been used to make moderate changes in emulsion viscoelasticity for droplet volume fractions above about φ>0.5 and higher. This restriction highlights that a general pathway to irreversibly transform an emulsion that resembles a simple viscous liquid into one that resembles an elastic solid by applying stresses through shear or flow without altering the emulsion's composition, especially at lower droplet volume fractions below about φ<0.5, has not yet been found.

The elasticity of glassy microscale emulsions of repulsive uniform droplets arises from the deformation of jammed disordered droplets (T. G. Mason, J. Bibette, and D. A. Weitz, Phys. Rev. Lett. 75, 2051 (1995); and T. G. Mason, M.-D. Lacasse, G. S. Grest, D. Levine, J. Bibette, and D. A. Weitz, Phys. Rev. E 56, 3150 (1997)). At low φ<φ_{MRJ}, where the droplets are not jammed, the emulsion resembles a simple viscous liquid; whereas, at large φ>φ_{MRJ}, the droplets repulsively jam and deform, and the emulsion resembles a solid. Here, φ_{MRJ}≈0.64 is associated with maximal-random jamming (MRJ) of spheres (S. Torquato, T. M. Truskett, and P. G. Debenedetti, Phys. Rev. Lett. 84, 2064 (2000)), formerly referred to as random close packing (RCP) (J. G. Berryman, Phys. Rev. A 27, 1053 (1983); and J. D. Bernal, and J. Mason, Nature 188, 910 (1960)). The linear elasticity of concentrated emulsions arises from the additional deformation of the jammed droplets induced by the applied perturbative shear, and the Laplace pressure scale of the undeformed droplets sets the scale of the shear elastic storage modulus, G′˜σ/a, where a is the droplet radius. This fundamental understanding of the elasticity of disordered deformable objects as a function of φ also explains G′ for foams of gas bubbles (A. Saint-Jalmes, and D. J. Durian, J. Rheol. 43, 1411 (1999)).

At present, no theory accurately predicts the linear shear modulus of emulsions by self-consistently including energy contributions from droplet deformation, entropy, and stabilizing repulsive interactions between droplet interfaces. Simulations of disordered uniform spherical droplets determined the repulsive jamming point to be φ≈0.64 (T. G. Mason, M.-D. Lacasse, G. S. Grest, D. Levine, J. Bibette, and D. A. Weitz, Phys. Rev. E 56, 3150 (1997); M.-D. Lacasse, G. S. Grest, and D. Levine, Phys. Rev. E 54, 5436 (1996); M.-D. Lacasse, G. S. Grest, D. Levine, T. G. Mason, and D. A. Weitz, Phys. Rev. Lett. 76, 3448 (1996); and C. S. O'Hern, S. A. Langer, A. J. Liu, and S. R. Nagel, Phys. Rev. Lett. 88, 075507 (2002)), in good agreement with experiments on monodisperse microscale emulsions. These simulations modeled the energy of deformation between two droplets, including the effects of the average local coordination number, using Surface Evolver (K. Brakke, Exp. Math. 1, 141 (1992)). Recent simulations of random monodisperse foam have provided a much more accurate picture of the structure (A. M. Kraynik, D. A. Reinelt, and F. van Swol, Phys. Rev. Lett. 93, 208302 (2004); and A. M. Kraynik, D. A. Reinelt, and F. van Swol, Phys. Rev. E 67, 031403 (2003)), but all simulations have neglected entropy and the electrostatic repulsions, instead treating interactions between the deformable surfaces as being “hard”. This is a reasonable assumption for most macroscale and microscale emulsions and even larger foam bubbles, since ionic surfactants, which strongly inhibit droplet coalescence through Debye-screened repulsions in the pair interaction potential, U, are very short in range compared to a. In this case, an effective volume fraction, φ_{eff}=φ(1+h/(2a))³, where h is the separation between droplet surfaces, effectively accounts for small corrections introduced by the short-range repulsion (T. G. Mason, M.-D. Lacasse, G. S. Grest, D. Levine, J. Bibette, and D. A. Weitz, Phys. Rev. E 56, 3150 (1997)).

The glaring weakness in the existing explanation of the elasticity of uniform disordered emulsions is the ad hoc assumption of a model for the film thickness, h(φ), that has been chosen to create a universal scaling curve of G′(φ_{eff}) Although the model for h(φ), which consists of a linear decrease from 17.5 nm at φ_{MRJ} to 5 nm at φ=1, is consistent with a measured value for the chosen stabilizer (T. G. Mason, and D. A. Weitz, Phys. Rev. Lett. 75, 2770 (1995)), it is very unlikely that this ad hoc model for h(φ) would be appropriate as the droplet radii approach the nanoscale. There is thus a need for improved methods of producing elastic materials from viscous materials and the materials made by such methods.

### SUMMARY

A method of producing an elastic material according to an embodiment of the current invention includes providing a viscous material having an initial material composition thereof the viscous material being a multiphase dispersion comprising a plurality of discrete elements of a first component dispersed within a continuous fluid phase of a second component; and applying stress to the plurality of discrete elements of the first component to break the plurality of discrete elements into a second plurality of discrete elements having a greater number of discrete elements than the first plurality of discrete elements. The discrete elements of the second plurality of discrete elements have at least one of a composition or a surface layer that provides at least a stabilizing repulsion between adjacent discrete elements to prevent the discrete elements from irreversibly coalescing or irreversibly re-uniting after said applying stress is completed, the viscous material thus becoming an elastic material having a same material composition as the initial material composition. Elastic materials are made according to embodiments of production of the current invention.

### BRIEF DESCRIPTION OF THE DRAWINGS

Additional features of this invention are provided in the following detailed description of various embodiments of the invention with reference to the drawings. Furthermore, the above-discussed and other attendant advantages of the present invention will become better understood by reference to the detailed description when taken in conjunction with the accompanying drawings, in which:

FIG. 1 shows the frequency dependence of the linear shear elastic storage modulus, G′(ω) (solid symbols), and loss modulus G″(ω) (open symbols), of a silicone PDMA oil-in-water emulsion with φ=0.40 and SDS surfactant concentration C_{SDS}=116 mM subjected to N=2 (triangles), 3 (squares), and 6 (circles) passes of extreme microfluidic flow at an input air pressure p=3.4 atm (which, after mechanical amplification of the device, corresponds to a fluid pressure driving the material flow through microchannels of about 820 atm) according to an embodiment of the current invention. As N increases, the nanoemulsion becomes a highly elastic glass with G′>G″ over a wide range of ω, corresponding to an elastic plateau that extends towards lower ω.

FIG. 1A shows small angle neutron scattering (SANS) measurements of the structure of an elastic nanoemulsion after N=7 passes through a high-pressure microfluidic device (75 micron channel width). Shown is the scattered neutron intensity, I, as a function of the wavenumber, q, as solid circles. The emulsion composition is PDMS silicone oil (10 cSt viscosity) in an aqueous surfactant solution of sodium dodecyl sulfate (SDS): droplet volume fraction φ=0.40, SDS concentration C_{SDS}=116 mM, and input air pressure to the microfluidic device of p=50 psi. The solid line is a fit to the form I(q)=I₀/[1+(qd)⁴], corresponding to a glassy emulsion that has a disordered configuration of droplets. The quality of the fit to this equation is excellent, confirming a disordered glassy structure of the droplets. The fit parameters are I₀=215±2 cm⁻¹ and d=12±1 nm. By contrast, I(q) for a strongly ordered emulsion or other ordered colloidal dispersion, such as a colloidal crystal, would exhibit very sharp Bragg peaks at higher values of q beyond the plateau region of intensity at low q. Since these Bragg peaks do not appear in our data, we have directly verified that the positional structure of the droplets in the elastic nanoemulsion, measured subsequent to said applying stress, is disordered.

FIGS. 2(a)-2(c) show that flow-induced vitrification of the emulsion of FIG. 1 is associated with droplet breakdown. FIG. 2(a) shows that the average droplet radius, <a>, decreases and then saturates. Bars denote the standard deviation, δa, not the error in the mean. An exponential decay with a constant saturation fits the data (line). FIG. 2(b) shows that the storage modulus, G′, at frequency ω=10 rad/s, increases many decades and saturates; this is fit by an exponential increase to a saturation (line). FIG. 2(c) shows that the lower crossover frequency, ω_{1c}, becomes very small for N≧4, signaling vitrification.

FIG. 3 shows the plateau elastic shear storage modulus, G′ₚ, as a function of droplet volume fraction, φ, for monodisperse nanoemulsions at C_{SDS}=10 mM and for average radii, <a>: 28 nm (triangles), 47 nm (circles), and 73 nm (squares) according to an embodiment of the current invention. The elastic onset for nanoemulsions occurs for swell below φ_{MRJ}≈0.64. For reference, G′ₚ for a much larger microscale emulsion with <a>=0.74 μm and the same C_{SDS} is also shown (open circles).

FIG. 4 shows a scaled interaction potential as a function of separation between the droplet surfaces, U(h)/a⁴, where a represents the average droplet radius, determined from all nanoemulsion data shown in FIG. 3 (same symbols). The line is a fit to a Debye-screened surface repulsion, yielding a Debye-screening length Of λ_{D}=3.8±0.5 nm. Inset: To determine h, G′ₚ from FIG. 3 are scaled with σ/a and shifted in φ onto a master curve: G′ₚ(φ_{eff})/(σ/a).

FIG. 5 shows measured peak amplitude of the shear stress, τ, as a function of imposed peak amplitude of the oscillatory shear strain, γ, at a frequency ω=10 rad/s for a viscous emulsion after being subjected to N=1 (circles), 2 (squares), 3 (triangles), and 6 (diamonds) passes through a high-pressure microfluidic device (75 micron channel width). The emulsion composition is PDMS silicone oil (10 cSt viscosity) in an aqueous surfactant solution of sodium dodecyl sulfate (SDS): droplet volume fraction φ=0.45, SDS concentration C_{SDS}=100 mM, and input air pressure to the microfluidic device of p=90 psi; the emulsion composition remains fixed and does not change as a function of N. At low strains, the stress-strain response is linear, corresponding to a slope of 1 on the log-log plot. The departure of the slope from linear behavior occurs when the stress exceeds the yield stress, τ_{y}. For applied strains that produce stresses that exceed τ_{y}, the peak stress exhibits a power law behavior with a slope less than unity. We have attempted to measure the stress-strain curve for N=0, but the torque lies below the measurable limit of the rheometer. Lines guide the eye.

FIG. 6 shows measured yield stress, τ_{y}, determined from the shear stress-strain data of FIG. 5 measured after a viscous emulsion has made N passes through a high-pressure microfluidic device (75 micron channel width). The emulsion is comprised of PDMS silicone oil (10 cSt viscosity) in an aqueous surfactant solution of sodium dodecyl sulfate (SDS): droplet volume fraction φ=0.45, SDS concentration C_{SDS}=100 mM, and input air pressure (to the microfluidic device) p=90 psi; the emulsion composition remains fixed and does not change as a function of N. Even after a single pass the yield stress has become measurable, and after several passes, it has exceeded the value required for the material to withstand typical gravitational stresses that would cause it to flow when a vessel containing it is tipped sideways.

FIG. 7 shows the average droplet radius, <a>, measured by dynamic light scattering (DLS) after a viscous emulsion has been subjected to N=4 passes through a high-pressure microfluidic device (75 micron channel size) and then has been aged at a temperature of 23° C. in a sealed vessel that inhibits evaporation over an aging time, t_{age}. The emulsion is comprised of PDMS silicone oil (10 cSt viscosity) in an aqueous surfactant solution of sodium dodecyl sulfate (SDS): droplet volume fraction φ=0.40, SDS concentration C_{SDS}=100 mM, and input air pressure (to the microfluidic device) p=120 psi. The bars represent the effective width of the size distribution, corresponding to the polydispersity of the radial size distribution to one standard deviation. The uncertainty of the mean of the radial size distribution due to DLS instrumental resolution in this experiment is about ±4 nm, so the average droplet radius has not evolved over more than three and a half years within the instrument's resolution.

FIG. 8 shows the plateau linear elastic shear modulus, G′ₚ (ω=10 rad/s) as a function of volume fraction φ for a monodisperse nanoemulsion (<a>=47 nm, C_{SDS}=10 mM) after being diluted with an aqueous surfactant solution at C_{SDS}=10 mM that also contains dissolved NaCl: C_{NaCl}=0 mM (red circles), 10 mM (blue upside-down triangles), 40 mM (diamonds) and 90 mM (right triangles).

FIG. 9 shows photographic images of the effect of elastic vitrification that can occur when a viscous microscale emulsion (φ=0.40, C_{SDS}=116 mM) is subjected to applied stress using extreme flow within a microfluidic homogenizer (input air pressure p=3.4 atm, channel width=75 microns) for N=2, 4, and 8 passes (from left to right) through the homogenizer according to an embodiment of the current invention. At large N=8, the interface between the emulsion (which appears grey) and the air (which appears black) within the vial remains vertical, indicating the considerable elasticity of the emulsion can overcome the forces of gravity (acting in a direction from the top to the bottom of the page) would otherwise cause a viscous material to flow until the interface becomes horizontal.

### DETAILED DESCRIPTION OF VARIOUS EMBODIMENTS

According to some embodiments of the current invention a liquid-like viscous material can be transformed into a solid-like elastic material through a history of extreme shear or flow without altering its composition. Thus, a physical process that causes an irreversible breakdown of the structures within the material can be used to dramatically transform the material's rheological behavior from that of a liquid to that of a solid. This is highly unusual, because many materials actually weaken irreversibly through fracture or relax back after being subjected to such high shear conditions.

Emulsions are dispersions of droplets of one liquid phase material in another immiscible liquid phase material that can be formed through flow-induced rupturing of bigger droplets into smaller ones. A surfactant that prefers adsorbing on the interfaces between the two liquids is usually added in order to prevent subsequent droplet coalescence (i.e. fusion) and to keep the size distribution of the droplets from changing over time. Emulsions are generally classified as oil-in-water (“direct”) and water-in-oil (“inverse”), and these different morphologies can be obtained by using an appropriate surfactant that provides adequate stability and through the order of addition of the components while shearing.

Oil-in-water emulsions comprised of microscale droplets are common products and have been made for centuries. A simple example is mayonnaise, typically made from egg yolk, which contains both stabilizing amphiphilic lipid and protein molecules, and olive oil that is added in a thin stream while beating the mixture with a whisk or spoon. Some of the mechanical shear energy is stored in the additional droplet interfacial area that is created as the droplets are ruptured down to a smaller size. Typical mechanical devices can produce shear rates that can achieve droplet rupturing down to droplet diameters that are typically around three hundred nanometers, but it is very difficult to achieve a reduction of the peak in the size distribution below this limit. Historically, sub-micron emulsions are known as “mini-emulsions”, and these have been created using microfluidic and ultrasonic means for the past twenty years. These methods provide extremely high shear or flow rates that can stretch and rupture even very small droplets. Indeed, there are reports in the literature of the use of ultrasonic dispersers or microfluidic homogenizers that have obtained droplets down into the nanoscale domain: the average droplet sizes are below 100 nm. There is some ambiguity in whether “size” refers to radius or diameter, but this factor of two is a very minor issue, considering the wide range of droplet sizes that can exist from the micellar scale of 2-3 nm all the way up to droplets having macroscopic dimensions.

Nanoemulsions that are elastic over a range of droplet volume fractions, φ, that are considerably below those typical of elastic microscale emulsions can be made according to some embodiments of the current invention. Whereas most microscale emulsions are elastic at droplet volume fractions (defined as the total volume of the droplets divided by the sum of the total volume of the droplets plus the total volume of the continuous phase) of about 60-70%, we have been able to make nanoemulsions according to embodiments of the current invention that have a significant elasticity at droplet volume fractions that are well below this, for the most extreme cases in the range of 20-30%, without having to add thickeners or other rheological adjustment agents. Technically, there is a volume fraction associated with the jamming of disordered monodisperse spheres, called the “maximally random jammed volume fraction”, or φ_{MRJ}≈0.64, and emulsions comprised of microscale or larger droplets only have measurable elasticities when the droplet volume fraction exceeds φ_{MRJ}. The source of the elasticity of such microscale and larger droplets is the additional deformation of the interfaces of droplets, which are already deformed by pressing against closely neighboring droplets, that is caused by an applied extensional or shear stress. By contrast, for nanoemulsions, the source of the elasticity is a combination of the repulsive potential between the droplet interfaces and the deformation of the droplets; for nanoemulsions that are excited by an extensional or shear stress, the droplets can remain relatively undeformed, yet the interdroplet repulsive energy per unit volume can be quite large due to the repulsive potential playing a much larger role in the elastic response for small droplet sizes.

The example below supports the interpretation that the elasticity of nanoemulsions can result from the stronger relative importance of the repulsive droplet interaction potential provided by the surfactant, not result only as a consequence of the deformation of the interfaces of jammed droplets that press up against each other, as is typical of most microscale emulsions. Regardless of the droplet size, the typical stabilizing film thickness is usually a few nanometers, and this creates a surface layer occupying a miniscule volume relative to the volume of the droplet for microscale droplets. However, for nanoscale droplets, the surface layer becomes a very substantial volume relative to the volume of the droplet, and, as a result, the emulsion becomes elastic due to droplets “pressing” up against their neighbors at much lower droplet volume fractions through the repulsive part of their interaction potential. This is illustrated in a striking way by the process that we show as an example herein where we take a microscale “premix” emulsion of silicone oil in water stabilized by SDS that behaves just as a viscous liquid at a droplet volume fraction of φ=0.35, well below the jamming point of hard spheres at φ_{MRJ}=0.64, subject it to extreme flow in a commercial high-pressure homogenizer, and then recover an elastic nanoemulsion having a disordered vitreous structure of droplets without ever changing the material's composition. This effect of irreversible elastic vitrification without changing composition is very unusual, and the only other materials that are even close to this are clay-polymer mixtures, called “shake-gels”, that restructure upon shear to give a temporary elasticity that dissipates rapidly over time. The nanoemulsions that we create by the process of elastic vitrification can remain elastic indefinitely, at least for several years and probably much longer, based on observations from our earliest samples. Control experiments show that the phenomenon of elastic vitrification is not due to alteration of the structure of the surfactant in the solution; it is generally due to an increase in the number of dispersed elements (e.g. droplets) and a corresponding reduction in the average volume or size of each of the dispersed elements. In addition, we can control the elasticity of the emulsion and cause it to disappear by screening the charge repulsive interactions at higher ionic strength in solution. Thus, salt water can be used to “melt” the solid-like disordered nanoemulsion into a liquid-like material. We anticipate that ion exchange resin can likewise be used to lower the ionic strength, reduce the Debye screening, and make the nanoemulsion elastic again.

We find that according to some embodiments of the current invention that the elastic vitrification becomes most pronounced for the smallest droplet sizes after rupturing and for the lowest ionic strengths. This is consistent with the interpretation that the relative importance of repulsive interaction between the droplet interfaces becomes more important in contributing to the elastic response of the material under those conditions. Since the principles are the same for cationic surfactants, we anticipate that these will also be elastic at low φ by the same physical mechanisms. Indeed, using a cationic surfactant, cetyl trimethylammonium bromide (CTAB), we have also demonstrated that elastic vitrification can be induced in an oil-in-water emulsion subjected to strong microfluidic homogenizing flows for φ well below φ_{MRJ}. For emulsions stabilized by non-ionic surfactants, achieving elastic vitrification at low φ by the same process of droplet breakdown using an applied stress could be created for surfactant molecules that extend at least several nanometers into the continuous phase once on the droplet interfaces. Certain Pluronic® surfactants are examples of non-ionic diblock surfactants that can stabilize droplets and extend significantly into the continuous phase.

Potential applications of elastic vitrification of emulsions by droplet breakdown into the nanoscale include uses in cosmetic products, personal care products, and food products. A reason for this is that rheology of a material determines how pleasing the application of the material on the skin is, and thin, runny liquids are generally not those preferred by people. Thicker materials that are smooth, but not lumpy, are generally more pleasing and easier to apply with less spilling. However, usually the non-aqueous ingredients, including the oil, are the most costly components of the product, so using less of any costly component and achieving the same feel may be a profitable alternative formulation that satisfies consumer demand, yet reduces the overall cost of the product. Another interesting potential application is in food products. For example, low-fat mayonnaise of nanoscale droplets that has more water than oil could be made according to embodiments of the current invention. We call this elastic vitreous material “nanonaise”. This process of elastic vitrification is a natural way of making low-fat emulsions that still retain the elastic properties that consumers expect of mayonnaise. Also, the optical properties of the nanoscale emulsions can be tailored to look clear, which may also indicate to consumers that there is less fat. The optical properties could also be controlled to look white by adding a very small number of larger droplets that cause multiple light scattering without significantly altering the elastic properties at low φ if a white appearance would be more appealing to consumers in some circumstances.

We believe that it will be possible for nanoemulsions, which exhibit the same elasticity as microscale emulsions but at a significantly lower droplet volume fraction, to become a major component of the offerings of companies in pharmaceuticals, personal care products, cosmetics, food products, and even potentially products such as paints and coatings.

### EXAMPLES

We demonstrate flow-induced “elastic vitrification” using an ionically stabilized model emulsion system according to an embodiment of the current invention. In particular, we subject a microscale silicone oil-in-water “premix” emulsion in this example at fixed φ<φ_{MRJ} to enormous extensional flow rates (i.e. ‘strain rates’) up to about 10⁸ s⁻¹. However, the general concepts of this invention are not limited to only these specific materials and are not limited to such high flow rates. The extreme stresses created by such strong flows or other means of excitation effectively rupture droplets down to nanoscale sizes, and the resulting disordered “glassy” nanoemulsion (T. G. Mason, J. N. Wilking, K. Meleson, C. B. Chang, and S. M. Graves, J. Phys.: Condens. Matter 18, R635 (2006)) can be quite elastic even though θ itself has not changed. By analogy to “mayonnaise”, which commonly refers to elastic emulsions of microscale droplets, we refer to elastic nanoemulsions as “nanonaise”. For ionically stabilized emulsions, as the rupturing occurs, h decreases towards the Debye-screening length, λ_{D}, and the droplets repulsively jam into what we refer to as a “Debye glass”. We attribute the large elasticity of the nanoemulsions at low φ to a combination of the increased influence of the Debye screened repulsions as well as to an overall increase in the Laplace pressure, Π_{L}=2σ/a, of the undeformed nanodroplets. Using a simple model for disordered networks of repulsive elements, we extract the average interaction potential as a function of separation between droplet interfaces, U(h), from G′(φ), and this potential is in satisfying agreement with a Debye-screening law. Thus, screened electrostatic repulsions between relatively undeformed nanodroplets play a key role in the elasticity of ionically stabilized nanoemulsions.

To make the premix emulsion according to this embodiment of the current invention, we disperse polydimethylsiloxane (PDMS), a type of “silicone oil”, into microscale droplets up to the desired φ into an aqueous solution of sodium dodecyl sulfate (SDS) at a concentration, C_{SDS}, typically above the critical micelle concentration (CMC) of 8 mM, using a mechanical mixer. The resulting microscale premix emulsion is polydisperse, having a broad size distribution centered at approximately <a>≈5 μm. The premixed emulsion provides a feed to a high-pressure “hard” stainless-steel/ceramic microfluidic flow device (Microfluidics Inc. Microfluidizers® model 110S) within which roughly 3 mL of emulsion is pulsed through microfluidic channels of 75 μm in a predominantly extensional flow geometry every second. The microfluidic device mechanically amplifies the input air pressure, p, by a factor of about 240 to create liquid pressures up to about 2400 atm. These significant liquid pressures in combination with the small microchannel thickness can create large peak extensional strain rates, [symbol] ≈10⁸ S⁻¹. These high flow rates, in turn, can create local stresses around droplets that effectively overcome surface tension to break up each individual microscale droplet into many smaller nanoscale droplets. To mitigate heating by viscous dissipation, the temperature of the output emulsion can be controlled using a heat exchanger. At φ=0, we have shown that the extreme flow does not alter the viscosity of the surfactant solution or cause the surfactant solution to become elastic by itself, thereby demonstrating that at least some dispersed elements of droplets are necessary to achieve elastic vitrification.

Because the flow in most microfluidic devices, including the specific model to which we have referred in the above example, is typically inhomogeneous, one can re-circulate, or “pass”, the emulsion through the microfluidic device more than once to ensure that all droplets experience the peak stress conditions that can be generated by the device. After each pass, N, we recover a small volume of the emulsion and perform standard small-strain linear oscillatory shear viscoelastic rheometry using cone-and-plate and small Couette geometries to determine the frequency-dependent storage modulus, G′(ω) and loss modulus, G″(ω). Dynamic light scattering (DLS) of highly diluted emulsions provides the average radius <a> and the standard deviation, δa. All measurements are conducted at room temperature, T=23° C.

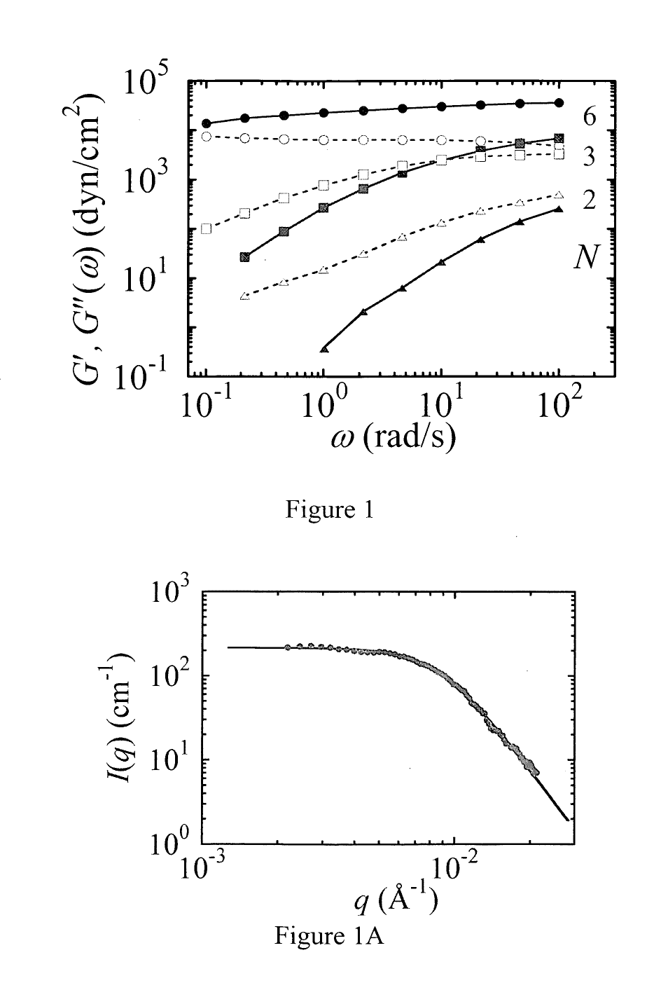

Although flow-induced elastic vitrification can be achieved in only one pass at the highest input air pressures p≈10 atm specified by the manufacturer, we use a lower p≈3.4 atm to show the hallmarks of vitrification over a larger range of N [FIG. 1]. For fixed C_{SDS}=116 mM, and φ=0.4, as N increases, a viscous response (G″>G′) for N=2 rapidly and systematically changes into an elastic response (G′>G″ for N≧6). A dominant elastic plateau, G′ₚ, develops upon repeated shearing (N>6). As G′ rapidly rises, the lower crossover frequency, ω_{1c}, (where G′=G″) also drops quickly, signaling the onset of vitrification. and the radial size polydispersity is typically about δa/<a>≈0.25, in accord with DLS, for N≧6.

Through neutron scattering, we have observed broad nearest neighbor peaks in the structure factor of the resulting vitrified droplets, these peaks are characteristic of a glassy solid, and these peaks are not Bragg peaks characteristic of a crystalline or polycrystalline solid. Neutron scattering experiments of elastic nanoemulsions that directly result from the process of applying stresses without any subsequent process of size fractionation and re-concentration reveal that the droplet structure is disordered and resembles a glass (see FIG. 1A). This experiment for confirming the glassy structure is fundamentally different than any prior neutron scattering measurements on nanoemulsions because such prior experiments relied upon the use of centrifugation and osmotic pressure to concentrate a dilute liquid-like nanoemulsion into a concentrated solid-like nanoemulsion (T. G. Mason, S. M. Graves, J. N. Wilking, and M. Y. Lin, J. Phys. Chem. 110, 22097 (2006)). This process of concentrating the droplets using ultracentrifugation involves a compositional change of the droplet volume fraction and is thus fundamentally different than the process described for the invention herein. This new evidence from neutron scattering that nanoemulsions produced directly by extreme flow have glassy structures is non-obvious since flow-induced ordering of particles and droplets is known to occur and since this can alter the effective volume fraction at which droplets pack, thereby influencing the elasticity.

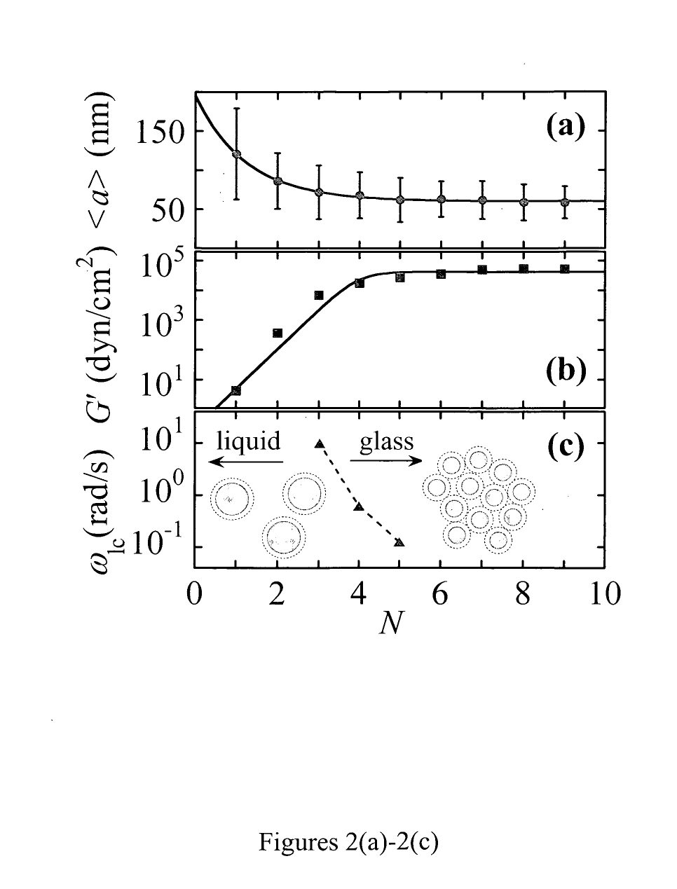

Flow-induced elastic vitrification at fixed φ is typically correlated with extreme droplet rupturing; a limited degree of flow-induced coalescence is permissible as long as the net effect of the flow creates an increase in the surface area-to-volume ratio of the dispersed elements. The increase and saturation in G′ₚ(N) corresponds to the reduction and saturation in <a(N)> [FIG. 2(a)-(b)]. We empirically fit <a(N)>=<aₛₐₜ>[1+βexp(−N/Nₐ)], where the subscript “sat” refers to saturation at N>>1, yielding <aₛₐₜ>=60±1 nm, β=2.3±0.1, and Nₐ=1.25±0.09. Here, Nₐ, refers to the 1/e value of the exponential decrease, so saturation occurs when N becomes several times Nₐ. Likewise, noting an exponential rise to a saturation, we fit G′ₚ(N)=G′ₚ₋ₛₐₜ[exp((N−Nₛₐₜ)/N_{G′})/(1+exp((N−Nₛₐₜ)/N_{G′}))], yielding G′ₚ₋ₛₐₜ=4.2±0.5×10⁴ dyn/cm², Nₛₐₜ=4.0±0.5, and N_{G′}=0.32±06. The correspondence of the saturation in G′p(N) and <a(N)> with Nₛₐₜ≈3Nₐ and the drop in ω_{1c} [FIG. 2(c)] indicate that elastic vitrification occurs as the droplets are broken down into the nanoscale regime.

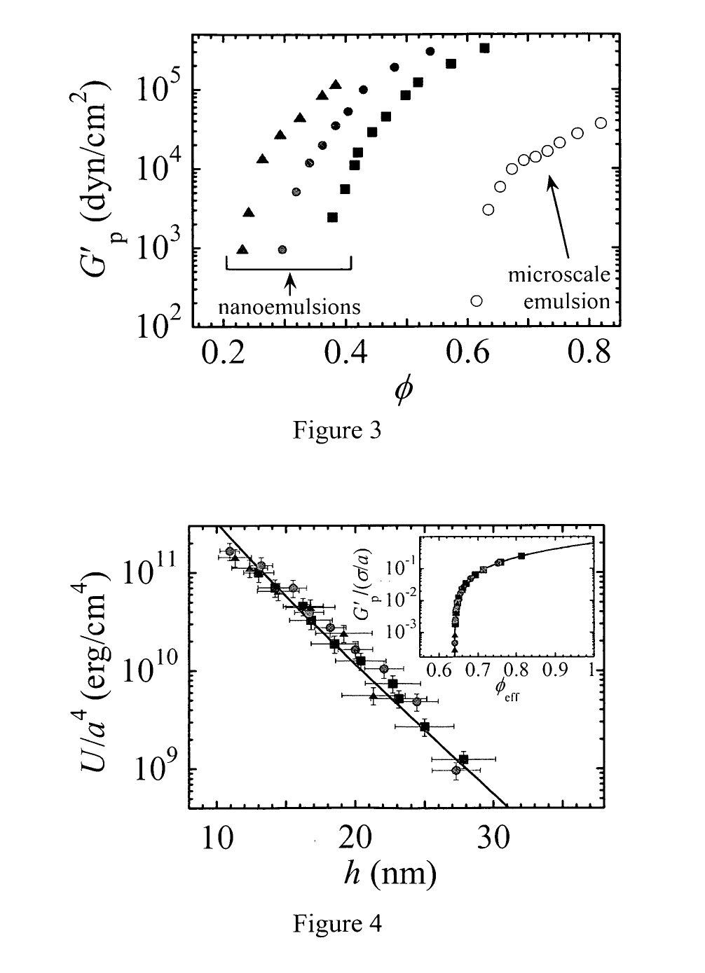

To study how G′ₚ changes with <a>, we size-fractionate nanoemulsions using ultracentrifugation to obtain a lower polydispersity δa/<a>≈0.15 while fixing C_{SDS}=10 mM (T. G. Mason, J. N. Wilking, K. Meleson, C. B. Chang, and S. M. Graves, J. Phys.: Condens. Matter 18, R635 (2006)). For each <a>, we set the largest φ by ultracentrifuging at 20,000 RPM, and then diluting each stock nanoemulsion with surfactant solution. Strikingly, the rise in G′ₚ(φ) [FIG. 3] for nanoemulsions can be found as low as φ≈0.23, much lower than φ_{MRJ}. The sharp rise in G′ₚ(φ) is followed by a more gradual increase toward large φ. This behavior is similar to G′ₚ(φ) for microscale emulsions, yet “nanonaise” is strongly elastic at much lower φ than has ever been previously observed for repulsive emulsions.

Using a simple model of disordered dispersed spherical elements that have at least a stabilizing repulsion at short distances, we obtain the droplet interaction potential, U(h), from G′ₚ(φ). Assuming z=6 nearest neighbors per droplet, the osmotic pressure is: Π(φ)≈3U(φ)/V_{uc}, where the unit cell volume, V_{uc}≈V_{d}/φ, and V_{d} is the volume of a droplet. For disordered repulsive networks under osmotic pressure, both experiments and simulations support the conjecture that G′ₚ(φ)≈Π(φ) (T. G. Mason, J. Bibette, and D. A. Weitz, Phys. Rev. Lett. 75, 2051 (1995)), so we find U(φ)≈G′ₚ(φ)V_{d}/3φ as the interaction energy per droplet-droplet “contact”. To determine h, we shift the measured G′ₚ/(σ/a) upward in φ so that it overlaps with the prediction for deformable droplets with “hard” interactions (T. G. Mason, M.-D. Lacasse, G. S. Grest, D. Levine, J. Bibette, and D. A. Weitz, Phys. Rev. E 56, 3150 (1997)): G′ₚ(φ_{eff})=1.74(σ/a)φ_{eff}(φ_{eff}−φ_{MRJ}) [FIG. 4—inset]. This shift provides φ_{eff}, and we calculate h=2a[(φ_{eff}/φ)^{1/3}−1], assuming the droplets are spherical. Since the Debye-screened repulsive potential is proportional to the square of the charge, we normalize U(h) by a⁴, assuming a constant surface charge density ρₛ for all <a>. This rescaling collapses all of the potentials onto a single master curve [FIG. 4], which we fit to B²ρₛ²exp(−h/λ_{D})/(h∈ᵣ), where B is a constant and ∈ᵣ=80 is the relative dielectric permittivity of water. For ρₛ=3.2×10³ esu/cm² and C_{SDS}=10 mM (F. Leal-Calderon, T. Stora, O. Mondain-Monval, P. Poulin, and J. Bibette, Phys. Rev. Lett. 72, 2959 (1994)), the fit yields B=5.9±0.4 and λ_{D}=3.8±0.5 nm, in good accord with the reported λ_{D}=3.5 nm (J. Marra, and M. L. Hair, J. Colloid Interface Sci. 128, 511 (1988)). The excellent collapse in FIG. 4 clearly demonstrates that a realistic model for U must be used to accurately predict G′ₚ of nanoemulsions at low φ.

In addition to providing a satisfying explanation of G′ₚ(φ) without resorting to an ad hoc expression for h(φ), our interpretation of nanoemulsion rheology provides a macroscopic method for measuring U(h) for soft, glassy repulsive colloidal suspensions of spheres. Through a repulsive contact-disorder (RCD) interpretation, which assumes that z=6, jamming occurs at φ_{MRJ}, and G′ₚ(φ)≈Π(φ), we obtain the microscopic U(h). In prior work on repulsive colloidal crystals, G′ₚ(φ) has been related to the microscopic U(h) essentially by assuming G′P(φ)≈K_{Π}(φ), where K_{Π}(φ) is the osmotic compressional modulus (R. Buscall, J. Chem. Soc. Faraday Trans. 87, 1365 (1991); and L. Raynaud, B. Ernst, C. Verge, and J. Mewis, J. Colloid Interface Sci. 181, 11 (1996)), and packing occurs at φ≈0.74 and z=12. When this approach for crystals is applied to glassy colloidal systems, it fails to provide the correct scaling and it does not yield realistic λ_{D} and ρₛ. By contrast, U(h) found using the RCD model is consistent with Bragg scattering experiments on magnetically manipulated ferrofluid emulsions at the same C_{SDS} (F. Leal-Calderon, T. Stora, O. Mondain-Monval, P. Poulin, and J. Bibette, Phys. Rev. Lett. 72, 2959 (1994)). Although the assumption G′_{P}(φ)≈Π(φ) has been confirmed by simulations (M.-D. Lacasse, G. S. Grest, D. Levine, T. G. Mason, and D. A. Weitz, Phys. Rev. Lett. 76, 3448 (1996)), it has received only minimal theoretical attention (S. Alexander, J. Phys. (France) 45, 1939 (1984)). In principle, the RCD approach can be applied to obtain U(h) when G′ₚ(φ) is known for any concentrated, soft, glassy repulsive colloidal system of spheres. By contrast, other techniques such as optical trapping (D. G. Grier, Curr. Opin. Colloid Interface Sci. 2, 264 (1997)), the surface forces apparatus (J. N. Israelachvili, Intermolecular and Surface Forces (Academic Press, London, 1992)), and ferrofluid emulsions (F. Leal-Calderon, T. Stora, O. Mondain-Monval, P. Poulin, and J. Bibette, Phys. Rev. Lett. 72, 2959 (1994)), are typically performed as φ→0. Nanoemulsions that are charge-stabilized, whether by cationic, anionic, charged polymer, or zwitterionic surfactants, may exhibit similar G′ₚ(φ) to what we have shown for anionic SDS surfactant, whereas nonionic- and uncharged-polymer-stabilized nanoemulsions could exhibit different G′ₚ(φ) due to repulsions related to molecular compressibility.

We have demonstrated the effect of elastic vitrification by breaking down microscale droplets into nanoscale droplets using extreme flows, the effect is more general than just for emulsions subjected to extreme flows in a microfluidic device. Other types of devices that can create extreme stresses on dispersed elements in a multiphase dispersion can be used to break down microscale and larger dispersed elements into a greater number of smaller elements that are typically below 100 nm in maximal linear dimension, thereby increasing the ratio of the total surface area of the dispersed elements divided by the total volume of the dispersed elements in the multiphase dispersion. Other types of devices that can apply stresses capable of breaking up dispersed elements include focused acoustic wave generators, ultrasonic devices, focused ultrasonic devices, homogenizers, mixers, colloid mills, and extruders. In addition, if there is at least a short-range repulsion in the interaction potential between the surfaces of the dispersed elements that has a range that is also between about one and one hundred nanometers, then the effect of elastic vitrification by breakup of the dispersed elements can occur. It is advantageous for the structure of the resulting elastic vitreous multi-phase dispersion to be disordered, since the effective volume fraction corresponding to jamming is lower than would be the case if the structure of the resulting multi-phase dispersion would be ordered or crystalline.

In summary, flow-induced elastic vitrification through irreversible structural breakdown of dispersed elements in a multiphase dispersion provides an exciting route for making nanoemulsions that are highly elastic at surprisingly low φ. These unusual and potentially useful properties of anionically stabilized nanonaise arise from the much greater relative importance of charge-screened repulsions between nanodroplets as a approaches λ_{D}. Based on our understanding of nanonaise, it is clear that a broader range of multiphase dispersions, not only emulsions, can exhibit irreversible elastic vitrification when a history of extreme stress is applied to cause the breakdown of repulsive elements in a fluid into a greater number of smaller repulsive elements that remain in the fluid. Our work highlights a need for a self-consistent theory that accurately predicts G′ₚ(φ) and Π(φ) of nanoemulsions, including repulsive interactions, droplet deformation, and entropy. Finally, we anticipate that careful macroscopic rheology of disordered vitreous nanoemulsions can provide a quantitative measurement of the microscopic interaction potential created by surfactants and other molecules that reside on the droplet surfaces.

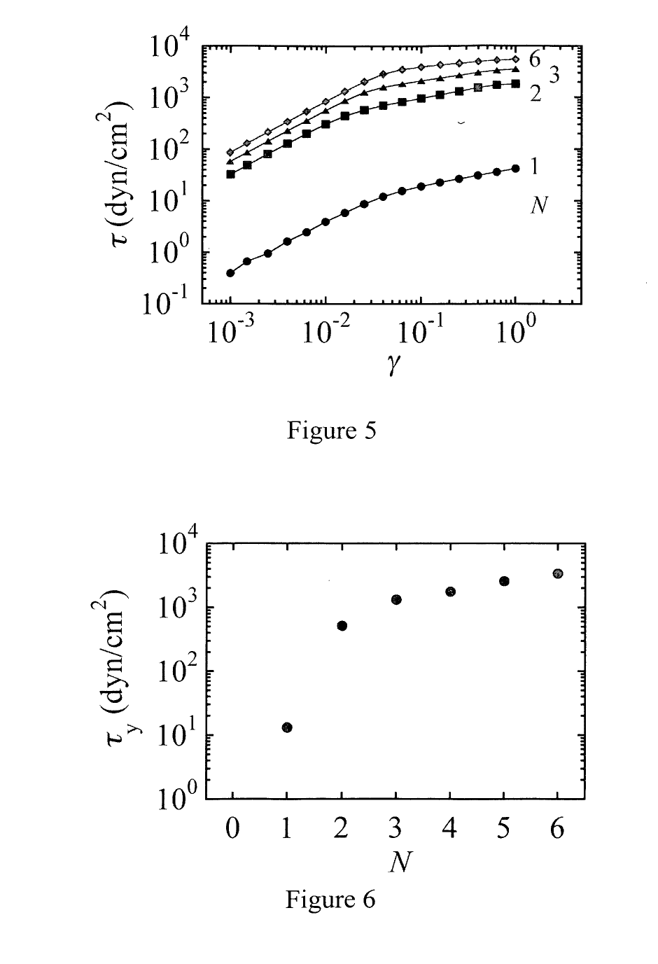

In addition to showing the increase in the plateau linear elastic shear modulus G′ₚ of the resulting emulsion with number of passes N through the high-pressure microfluidic device, we have also demonstrated that the yield stress τ_{y} response to an imposed shear increases as a function of N. (See FIGS. 5 and 6.)

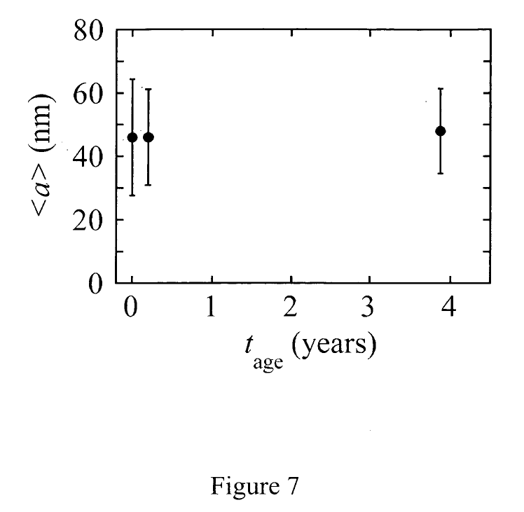

FIG. 7 demonstrates that the reduction of the droplet sizes achieved by applied stress is irreversible over very long times scales. This means that long-time aging of the elastic material does not result in any change in the size distribution over many years, to within the measurement uncertainty of the dynamic light scattering (DLS) instrument we use to determine the droplet size. Since the elasticity of the emulsion has been correlated to the average droplet size, this data also implies that the elastic shear modulus of the elastic material does not change appreciably over time, even over the scale of years. This can be important for shelf life of a product.

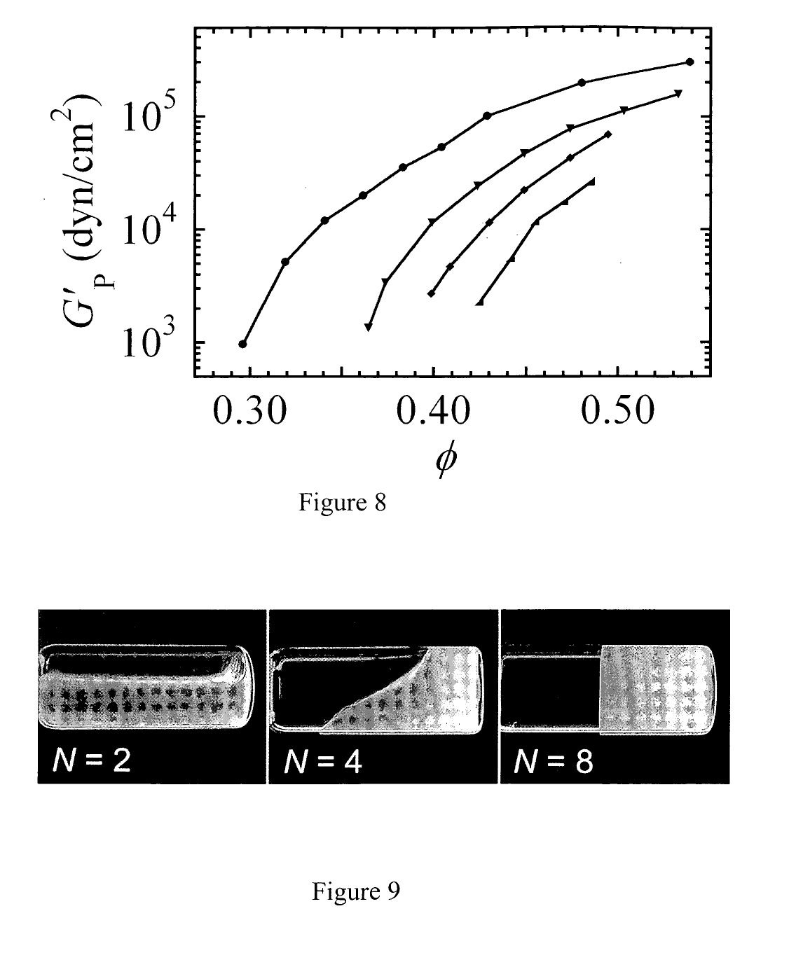

FIG. 8 shows the plateau linear elastic shear modulus, G′_{P} (ω=10 rad/s) as a function of volume fraction φ for a monodisperse nanoemulsion (<a>=47 nm, C_{SDS}=10 mM) after being diluted with an aqueous surfactant solution that also contains dissolved NaCl: C_{NaCl}=0 mM (red circles), 10 mM (blue upside-down triangles), 40 mM (green diamonds) and 90 mM (black right triangles). Thus, the concentration of salt in the continuous phase alters the range of repulsive interactions between the droplets and can be used to control the elasticity of the resulting emulsion.

FIG. 9 shows a viscous microscale emulsion (φ=0.40, C_{SDS}=116 mM) after being subjected to extreme mechanical flow within the microfluidic homogenizer (input air pressure p=3.4 atm). The emulsion has been flowed through the microfluidic homogenizer for N passes, a subsample after each pass is placed in upright glass vials, and images are taken several minutes after the sample vial was turned on its side. Earth's gravity points downward (from the top of the page to the bottom). The vials are approximately 1 cm in diameter, and the emulsion appears hazy; the black region is just occupied by air. The emulsion becomes more elastic after it has been subjected to a history of strong flow, as evidence by the inability of the earth's gravitational field to cause the boundary between the air and the emulsion. At a low pass number (N=2) the emulsion material is viscous and flows so that the normal to the surface is along the direction of gravity; at high pass number (N=8) the multiphase material is elastic and does not flow so that the normal to the surface remains perpendicular to gravity, even over long times (i.e. days, weeks, and months).

We have validated that the elastic vitrification is irreversible not only by showing that the droplet size distribution has not appreciably changed, but also through linear viscoelastic rheometry measurements. For this experiment, the emulsion composition is PDMS silicone oil (10 cSt viscosity) in an aqueous surfactant solution of sodium dodecyl sulfate (SDS): droplet volume fraction φ=0.4, SDS concentration C_{SDS}=116 mM, and input air pressure to the microfluidic device of p=50 psi, after N=6 passes through the microfluidic device (75 micron channel width). The plateau elastic shear modulus G′ₚ was measured to be G′ₚ=(3±1)×10⁴ dyn/cm² initially right after the process was completed. After an aging time of 461 days, we re-measured G′ₚ for the same sample that had been kept in a glass jar with a teflon-coated screw cap at a temperature of 23° C., and we found G′ₚ=(5±1)×10⁴ dyn/cm². Within the experimental uncertainty due to loading conditions of the mechanical rheometer, these values are essentially the same, so we conclude that the process of elastic vitrification of the emulsion is irreversible and the large elastic shear modulus that was created through the process remains unchanged over more than a year.

In addition to demonstrating elastic vitrification for silicone oil droplets dispersed in anionic surfactants, we have shown that the same effect of elastic vitrification occurs for silicone oil droplets dispersed in aqueous solutions of cationic surfactants. In particular, we have used the process of elastic vitrification to make PDMS silicone oil (10 cSt viscosity) in an aqueous surfactant solution of the cationic surfactant cetyl trimethylammonium bromide (CTAB): droplet volume fraction φ=0.4, CTAB concentration C_{CTAB}=200 mM, and input air pressure to the microfluidic device of p=90 psi, after N=6 passes through the microfluidic device (75 micron channel width). This validates that the process of elastic vitrification occurs more generally for materials other than silicone oil-in-water emulsions stabilized by anionic surfactants such as SDS.

The invention has been described in detail with respect to various embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. A method of producing an elastic material, comprising:
providing a viscous material having an initial material composition thereof, said viscous material being a multiphase dispersion comprising a plurality of discrete elements of a first component dispersed within a continuous fluid phase of a second component; and
applying stress to said plurality of discrete elements of said first component to break up said plurality of discrete elements into a second plurality of discrete elements having a greater number of discrete elements than said first plurality of discrete elements,
wherein said discrete elements of said second plurality of discrete elements have at least one of a composition or a surface layer on each element that provides at least a repulsive interaction between adjacent discrete elements to prevent said discrete elements from irreversibly coalescing or irreversibly re-uniting after said stress has been removed, said viscous material thus irreversibly becoming an elastic material having a same material composition as said initial material composition.

2. A method of producing an elastic material according to claim 1, wherein said second component of said viscous material is at least one of a liquid material, a liquid solution, and a liquid-based dispersion.

3. A method of producing an elastic material according to claim 1, wherein said first component of said viscous material is at least one of a liquid material, a liquid solution and a liquid-based dispersion, said first component being immiscible with said second component.

4. A method of producing an elastic material according to claim 2, wherein said first component of said viscous material is at least one of a liquid material, a liquid solution and a liquid-based dispersion, said first component being immiscible with said second component.

5. A method of producing an elastic material according to claim 1, wherein said viscous material further comprises a stabilizing agent therein, said stabilizing agent providing at least a portion of said repulsive interaction between adjacent discrete elements of said second plurality of discrete elements.

6. A method of producing an elastic material according to claim 5, wherein said stabilizing agent is selected from at least one of a surfactant, an anionic surfactant, a cationic surfactant, a zwitterionic surfactant, a nonionic surfactant, a detergent, an emulsifier, an amphiphilic molecule, a lipid, a di-block polymer, a copolymer, a graft copolymer, an amphiphilic graft copolymer, a biopolymer, a co-polypeptide, a polysaccharide, a protein, an acid, a polymeric acid, a base, a polymeric base, a salt, a polymeric salt, a polymer of nucleic acids, a deoxribonucleic acid, a ribonucleic acid, a functionalized molecule, a derivatized molecule, a nanoparticle, and a surface-functionalized nanoparticle.

7. A method of producing an elastic material according to claim 5, wherein said stabilizing agent is at least 0.1% by mass of said viscous material.

8. A method of producing an elastic material according to claim 5, wherein said stabilizing agent is at least 1% by mass of said viscous material.

9. A method of producing an elastic material according to claim 5, wherein said stabilizing agent is at least 10% by mass of said viscous material.

10. A method of producing an elastic material according to claim 1, wherein said applying stress to said plurality of discrete elements of said first component comprises at least one energetic excitation selected from the group of energetic excitations consisting of a shear flow, an extensional flow, a viscous flow, a plastic flow, a visco-elastic flow, a yielding flow, a mechanical extrusion, an extrusion through a solid porous membrane, an extrusion through a solid channel, an extrusion through a microchannel, an extrusion through a nanochannel, a mechanical milling, a mechanical mixing, a microfluidic flow, a high-pressure microfluidic flow, a homogenization flow, a cavitation flow, a turbulent flow, a transient flow, a pulsed flow, an acoustic wave, a focused acoustic wave, an ultrasonic excitation, a focused ultrasonic excitation, an electromagnetic excitation, an electric field, a thermal excitation, a localized thermal excitation, a thermal gradient, and a chemical reaction.

11. A method of producing an elastic material according to claim 1, wherein said applying stress to said plurality of discrete elements of said first component provides a stress on said plurality of discrete elements of said first component that is greater than about 10⁴ dyne/cm².

12. A method of producing an elastic material according to claim 1, wherein said applying stress to said plurality of discrete elements of said first component produces a strain rate of at least about 10⁶ s⁻¹.

13. A method of producing an elastic material according to claim 1, wherein said first component of said viscous material comprises an oil and said second component of said viscous material comprises an aqueous solution of a surfactant.

14. A method of producing an elastic material according to claim 1, wherein said second component of said viscous material comprises at least one of an oil or a solution of oil-soluble molecules dissolved in an oil;
and said first component of said viscous material comprises at least one of water and a solution of water-soluble molecules dissolved in water.

15. A method of producing an elastic material according to claim 13, wherein said applying stress to said plurality of discrete elements of said first component comprises at least one of applying a high-pressure microfluidic flow and applying a homogenizing flow.

16. A method of producing an elastic material according to claim 1, wherein the ensemble-averaged maximum dimension of said second plurality of discrete elements is greater than about 1 nm and less than about 200 nm.

17. A method of producing an elastic material according to claim 1, wherein said elastic material has a linear elastic shear storage modulus that is at least 1 dyne/cm² for at least one frequency within a range of frequencies greater than about 10⁻⁵ s⁻¹ and less than about 10⁵ s⁻¹.

18. A method of producing an elastic material according to claim 1, wherein said elastic material is at least one of a cosmetic, a personal care product, a pharmaceutical, and a food product.

19. A method of producing an elastic material according to claim 1, further comprising diluting said elastic material subsequent to said applying stress to provide a decrease in concentration of said second plurality of discrete elements of said elastic material.

20. A method of producing an elastic material according to claim 1, further comprising concentrating said elastic material subsequent to said applying stress to provide an increase in concentration of said second plurality of discrete elements of said elastic material.

21. A method of producing an elastic material according to claim 1, wherein said discrete elements of said second plurality of discrete elements have at least one of a composition or a surface layer that provides long range attraction between adjacent discrete elements.

22. A method of producing an elastic material according to claim 1, wherein said first component of said viscous material is at least about 10% by volume of a total volume of said multiphase dispersion of said viscous material.

23. A method of producing an elastic material according to claim 1, wherein said first component of said viscous material is at least about 20% and less than about 80% by volume of a total volume of said multiphase dispersion of said viscous material.

24. A method of producing an elastic material according to claim 1, further comprising applying stress to said plurality of discrete elements of said second component after the first mentioned applying stress to said plurality of discrete elements of said first component to break said plurality of discrete elements into a third plurality of discrete elements having a greater number of discrete elements than said second plurality of discrete elements.

25. A method of producing an elastic material according to claim 1, wherein said first component of said viscous material, that is dispersed within said continuous fluid phase of said viscous material, is selected from the group of materials consisting of a viscous liquid, a liquid solution containing liquid-soluble molecules, a liquid solution containing drug molecules, a polar liquid, a non-polar liquid, an aliphatic liquid, a wax, a lipid, a fat, a petroleum liquid, a plant extract, a nut extract, a plant product, an animal product, a juice, a concentrate, an emollient, a tackifier, a pigment, a moisturizer, a fragrance, an oil, a poly-siloxane, a polymer, a polymer solution, a polymer gel, a biopolymer solution, a nanoemulsion, a dispersion of nanoparticles in a liquid, a ferrofluid, a liquid crystal, a thermotropic liquid crystal, a lyotropic liquid crystal, a solid material, an elastic material, a viscoelastic material, a viscoplastic material, a glassy material, an aggregate of nanoparticles, an aggregate of molecules, an aggregate of platelets, an aggregate of a solid material, an aggregate of a polymeric material, an aggregate of asphaltenes, an aggregate of crystals, a supercritical fluid, and a complex fluid.

26. A method of producing an elastic material according to claim 1, wherein said second component of said viscous material is selected from the group of materials consisting of a viscous liquid, a liquid solution containing liquid-soluble molecules, a liquid solution containing drug molecules, a polar liquid, a non-polar liquid, an aliphatic liquid, a wax, a lipid, a fat, a petroleum liquid, a plant extract, a nut extract, a plant product, an animal product, a juice, a concentrate, an emollient, a tackifier, a pigment, a moisturizer, a fragrance, an oil, a poly-siloxane, a polymer, a polymer solution, a polymer gel, a biopolymer solution, a nanoemulsion, a dispersion of nanoparticles in a liquid, a ferrofluid, a liquid crystal, a thermotropic liquid crystal, a lyotropic liquid crystal, a solid material, an elastic material, a viscoelastic material, a viscoplastic material, a glassy material, an aggregate of nanoparticles, an aggregate of molecules, an aggregate of platelets, an aggregate of a solid material, an aggregate of a polymeric material, an aggregate of asphaltenes, an aggregate of crystals, a supercritical fluid, and a complex fluid.

27. A method of producing an elastic material according to claim 1, wherein the volume fraction given by the volume of said first component of said viscous material divided by the total volume of said viscous material is less than about a maximally random jammed volume fraction of about 0.64.

28. A method of producing an elastic material according to claim 1, wherein said second plurality of discrete elements are charge stabilized and have an average maximum dimension that is smaller than about twenty-five times the Debye screening length for said elastic material.

29. A method of producing an elastic material according to claim 1, wherein said discrete elements of said second plurality of discrete elements have a disordered positional structure that is characteristic of a glass.

30. A method of producing an elastic material according to claim 1, wherein said discrete elements of said second plurality of discrete elements have a greater ratio of total-surface-area to volume than said discrete elements of said first plurality of discrete elements.

31. A method of producing an elastic material according to claim 1, wherein at least a portion of energy used in said applying stress is stored in said elastic material produced.

32. A method of producing an elastic material according to claim 1, wherein a size distribution of said discrete elements of said second plurality of discrete elements remains substantially constant over time after said applying stress.

33. A method of producing an elastic material according to claim 1, wherein said elastic material exhibits a linear elastic shear storage modulus that remains substantially constant over time after said applying stress.

34. A method of producing an elastic material according to claim 1, wherein said elastic material exhibits a yield stress that exceeds 10 dyn/cm² after said applying stress.

35. An elastic material produced according to the method of claim 1.
